(19) United States
(12) Patent Application Publication
(10) Pub. No.: US 2018/0200984 A1
(43) Pub. Date: Jul. 19, 2018

(54) NONWOVEN FABRIC COMPOSITE AND METHOD FOR MANUFACTURING THE SAME

(71) Applicants: KURARAY LIVING CO., LTD., Osaka-shi (JP); FOSHAN NAHAI BEAUTIFUL NONWOVEN CO., LTD., Foshan City (CN)

(72) Inventors: Eiji AKIBA, Osaka (JP); Weixiong DENG, Guangdong (CN)

(73) Assignees: KURARAY LIVING CO., LTD., Osaka-shi (JP); FOSHAN NAHAI BEAUTIFUL NONWOVEN CO., LTD., Foshan City (CN)

(21) Appl. No.: 15/744,546

(22) PCT Filed: Jul. 12, 2016
(86) PCT No.: PCT/JP2016/003291

§ 371 Date: Jan. 12, 2018

(30) Foreign Application Priority Data
Jul. 13, 2015 (JP) 2015-139934

(51) Int. Cl. B32B 5/10; D04H 3/007; D04H 3/011; D04H 3/009; D04H 3/16; B32B 5/02; B32B 5/26

(52) U.S. Cl. CPC B32B 5/10; D04H 3/007; D04H 3/011; D04H 3/009; D04H 3/16; B32B 5/022; B32B 2307/21; D10B 2401/16; B32B 2262/0253; B32B 2262/0276; B32B 2262/0261; B32B 2307/202; B32B 5/26

(57) ABSTRACT

A nonwoven fabric composite 1 includes: a multilayer and long-fiber nonwoven fabric (A) which is a laminate of nonwoven fabrics continuously obtained through spinning melted resin formable into fibers; and a yarn (B) formed of fibers different from the fibers forming the multilayer and long-fiber nonwoven fabric (A), and introduced in the multilayer and long-fiber nonwoven fabric (A) by in-line lamination. The fibers of the yarn (B) include electrically conductive fibers.

### TECHNICAL FIELD

The present invention relates to a nonwoven fabric composite including: a multilayer and long-fiber nonwoven fabric; and a yarn containing functional fibers and introduced in the multilayer and long-fiber nonwoven fabric. The present invention also relates to a method for manufacturing the nonwoven fabric composite.

### BACKGROUND ART

Recent years have seen an increasing use of long-fiber nonwoven fabrics containing thermoplastic polymer and prepared through one continuous process of forming a fabric including melt spinning continuously followed by forming a nonwoven fabric. Known, methods for manufacturing such a nonwoven fabric includes a spunbond technique: Polymer is extruded from a nozzle having multiple holes and stretched by passing hot air to form fibers. The fibers are then dispersed at random on a net and heat-sealed together between heat embossing rolls to be fixed to each other. Another known method is a melt blowing technique: Polymer extruded from a nozzle having multiple holes is blown by high-pressure hot air to be extremely fine fibers. The extremely fine fibers are sprayed on an air-permeable mesh to form a nonwoven fabric.

A melt-blown nonwoven fabric (M) containing the extremely tine fibers excel in filtering. Together with a spunbond nonwoven fabric (S), the melt-blown nonwoven fabric (M) is formed into a multilayer laminate haring, for example, a three-layer laminate of SMS. This structure nukes the fabric dust- and water-proof, while the cloth of the fabric is approximately the same in strength elongation as knitted and woven cloth for clothing. Such an SMS fabric is widely used for work clothes, packing materials, household products, and building materials. In particular, common surgical gowns are made of a disposable SMMMS fabric in view of preventing infection.

Moreover, when a multilayer and long-fiber nonwoven fabric as represented by the SMS laminate is used for work clothes, the fabric can be provided with various functions such as antistatic, hydrophilic, water-repellent, and insect-repellent properties, depending on uses of the clothes. Examples of a suggested processing method to provide such functions include applying a functional agent such as an antistatic agent, a hydrophilic agent, a water repellent, and an insect repellent to the nonwoven fabric or immersing the nonwoven fabric in the functional agent.

Here, for example, two kinds of techniques are suggested to provide a nonwoven fabric with antistatic properties for reducing generation of static electricity. One of the techniques involves mixing or applying a hydrophilic antistatic agent with or to the nonwoven fabric. The agent absorbs moisture in the air so that the moisture reduces the risk of generating static electricity. (See PATENT DOCUMENT 1, for example.)

The other technique involves introducing conductive fibers in a nonwoven fabric so that the conductive fibers leak and remove the static electricity generated in the nonwoven fabric, or the conductive fibers remove static electricity nearby through corona discharge.

Such antistatic properties are required in various areas. Examples of the properties include keeping clothes from generating uncomfortable static charge, attracting dust in the air, or discharging static electricity followed by ignition and explosion. For example, work clothes for a field in which a flammable organic solvent and dust are handled shall comply with explosion-proof standards according to JIST 8118 in order to reduce the risk of explosion.

### CITATION LIST

### Patent Documents

PATENT DOCUMENT 1: Japanese Unexamined Patent Publication No. 2011-202301

PATENT DOCUMENT 2: Japanese Unexamined Patent Publication No. 2010-1576

### SUMMARY OF THE INVENTION

### Technical Problem

The technique disclosed in PATENT DOCUMENT 1 is, however, directed to a method for manufacturing a nonwoven fabric, using carding of short fibers and spunlacing. The method includes: manufacturing, from thermoplastic resin, a tow to be used as a raw material of the short fibers; stretching the tow and providing the tow with heat-setting and an antistatic agent, and cutting the tow into short fibers, and carding and spunlacing the short fibers to form a nonwoven fabric. Hence, the method has problems of a complex manufacturing process and increasing manufacturing costs.

Furthermore, in the method disclosed in PATENT DOCUMENT 1, moisture required for antistatic properties, cannot be obtained under a low-humidity condition (e.g., 20% RH or below). Such a problem makes it difficult to ensure prevention of generating static electricity, and as a result, to dear the explosion-proof standards.

Moreover, the technique disclosed in PATENT DOCUMENT 2 is directed to a method for manufacturing a nonwoven fabric containing a 2% of short fibers including electrically conductive fibers. The method includes: manufacturing, from thermoplastic resin, a tow to be used as a raw material a short fibers; stretching the tow and providing the tow with heat-setting and antistatic agent, and cutting the tow into short fibers; and carding and partially heat-sealing the short fibers to form a nonwoven fabric. Hence, the method has problems of a complex manufacturing process and increasing manufacturing costs.

In view of the forgoing background, one or more aspects of the present invention are directed to a nonwoven fabric composite which can easily clear explosion-proof standards at low costs thanks to processes fewer than those required for a typical nonwoven fabric composite. The present invention also attempts to a method for manufacturing the nonwoven fabric composite.

### Solution to the Problem

In order to achieve the above one or more aspects, a nonwoven fabric composite of the present invention includes: a multilayer and long-fiber nonwoven fabric (A) which is a laminate of nonwoven fabrics continuously obtained through spinning melted resin formable into fibers; and a yarn (B) formed of fibers different from the fibers forming the multilayer and long-fiber nonwoven fabric (A), and introduced in the multilayer and long-fiber nonwoven fabric (A) by in-line lamination. The fibers of the yarn (B) include electrically conductive fibers.

Moreover, a method of the present invention relates to manufacturing a nonwoven fabric composite including a multilayer and long-fiber nonwoven fabric (A) which is a laminate of nonwoven fabrics continuously obtained through spinning melted resin formable into fibers; and a yarn (B) formed of fibers different from the fibers forming the multilayer and long-fiber nonwoven fabric (A), and introduced in the multilayer and long-fiber nonwoven fabric (A). The method includes introducing the yarn (B) by in-line lamination during manufacturing of the multilayer and long-fiber nonwoven fabric (A). The fibers of the yarn (B) include electrically conductive fibers.

### Advantages of the Invention

The present invention can offer a nonwoven fabric composite which can achieve good antistatic properties under a low-humidity condition with a low-cost and simple technique. The present invention can also offer a method for manufacturing the nonwoven fabric composite.

### BRIEF DESCRIPTION OF THE DRAWINGS

FIG. 1 is a plan view illustrating a nonwoven fabric composite according to an embodiment of the present invention.

FIG. 2 is a cross-sectional view taken along the line F-F of FIG. 1, illustrating the nonwoven fabric composite according to the embodiment of the present invention.

FIG. 3 is a schematic view illustrating a method for manufacturing the nonwoven fabric composite according to the embodiment of the present invention.

FIG. 4 is a schematic view illustrating a method for how to introduce a yarn in the method for manufacturing the nonwoven fabric composite according to the embodiment of the present invention.

FIG. 5 is a schematic view illustration a positioning guide to be used for the method for manufacturing the nonwoven fabric composite according to the embodiment of the present invention.

FIG. 6 is a schematic view illustrating a modification of the method for manufacturing the nonwoven fabric composite according to the embodiment of the present invention.

FIG. 7 is a cross-sectional view illustrating a modification of the nonwoven fabric composite according to the embodiment of the present invention.

FIG. 8 is a schematic view illustrating a modification of the method for manufacturing the nonwoven fabric composite according to the embodiment of the present invention.

FIG. 9 is a cross-sectional view illustrating a modification of the nonwoven fabric composite according to the embodiment of the present invention.

FIG. 10 is a schematic view illustrating a modification of the method for manufacturing the nonwoven fabric composite according to the embodiment of the present invention.

FIG. 11 is a cross-sectional view illustrating a modification of the nonwoven fabric composite according to the embodiment of the present invention.

FIG. 12 is a plan view illustrating a modification of the nonwoven fabric composite according to the embodiment of the present invention.

### DETAILED DESCRIPTION

An embodiment of the present invention will be described in detail below, with reference to the drawings. The present invention is not limited to the embodiment below

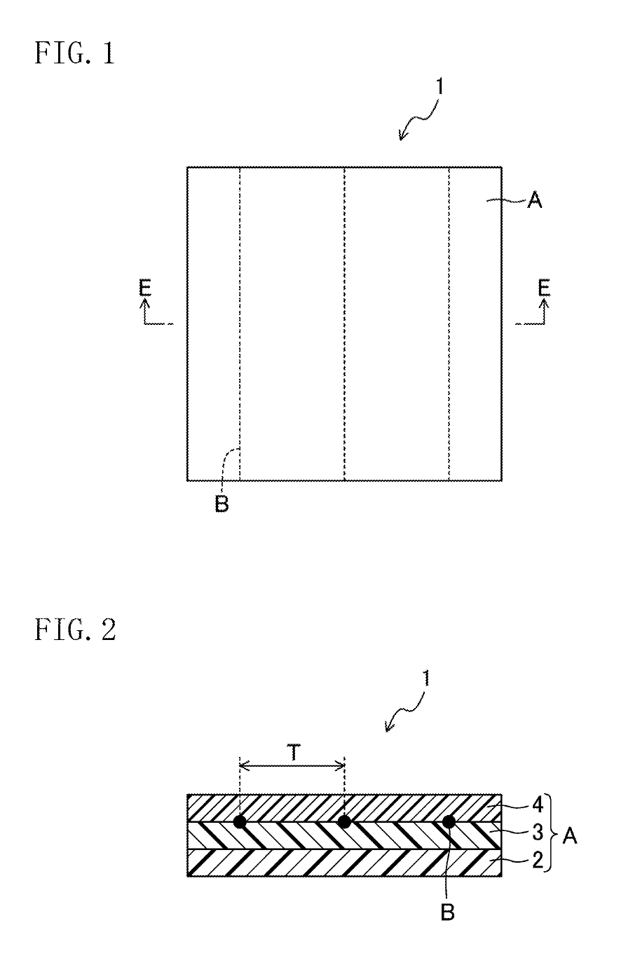

FIG. 1 is a plan view illustrating a nonwoven fabric composite according to an embodiment of the present invention. FIG. 2 is a cross-sectional view taken along the line E-E of FIG. 1, illustrating the nonwoven fabric composite according to the embodiment of the present invention.

A nonwoven fabric composite 1 of this embodiment includes: a multilayer and long fiber nonwoven fabric (A) which is a laminate of nonwoven fabrics 2 to 4 continuously obtained through spinning of melted resin formable into fibers; and a yarn (B) formed of fibers different from the fibers forming the multilayer and long-fiber nonwoven fabric (A) and introduced in the multilayer and long-fiber nonwoven fabric (A) by in-line lamination.

The nonwoven fabrics 2 to 4 can be continuously obtained through spinning of melted resin formable into fibers. Examples of the resin to be formed into these nonwoven fabrics 2 to 4 include polypropylene, polyethylene, polyester, and polyamide. Moreover, modified polymer made from these resins can be used. Note that these resins can be used alone, or in a combination of two or more.

The multilayer and long-fiber nonwoven fabric (A) included in the nonwoven fabric composite 1 of the present invention contains at least one of a spunbond nonwoven fabric or a melt-blown nonwoven fabric. As illustrated in FIG. 2, for example, the multilayer and lone-fiber nonwoven fabric (A) of this embodiment is a three-layer laminate (an SMS laminate) including the spunbond nonwoven fabrics 2 and 4 and the melt-blown nonwoven fabric 3 alternately laminated (two layers of the spunbond nonwoven fabrics 2 and 4 and one layer of the melt-blown nonwoven fabric 3 are alternately laminated), with the melt-blown nonwoven fabric 3 provided as an intermediate layer.

Moreover, an average fiber diameter of the fibers contained in the spunbond nonwoven fabrics 2 and 4 may preferably range from 5 μm to 50 μm in view of obtaining good spinning yarns without shot and broken yarns and achieving the balance of the strength elongation of the fibers, depending on a kind of polymer and the amount of molecules. More preferably, the average fiber diameter may range from 10 μm to 40 μm and in particular, from 15 μm to 30 μm.

Note that the “average fiber diameter” here is a diameter of a single fiber when the cross section of the fiber is round. When the cross section is not round, the average fiber diameter is an average of a long diameter and a short diameter.

Moreover, an average fiber diameter of fibers contained in the melt-blown nonwoven fabric 3 preferably ranges from 0.1 μm to 4.0 μm, more preferably from 0.2 μm to 2.0 μm, and in particular from 0.5 μm to 1.0 μm. Thanks to these average fiber diameters, diameters of the fibers in a melt-blown nonwoven fabric can be as uniform as possible to achieve a uniform pore size. Such a feature successfully provides the melt-blown nonwoven fabric with predetermined filtration capabilities.

Note that the “average fiber diameter” here is a diameter of a single fiber when the cross section of the fiber is round. When the cross section is not round, the average fiber diameter is an average of a long diameter and a short diameter.

Moreover, the spunbond nonwoven fabrics 2 and 4 can be manufactured by a well-known spunbond technique. The melt-blown nonwoven fabric 3 can be manufactured by a well-known melt-blown technique.

A basis weight of a multilayer nonwoven fabric of the present invention is not limited to a particular weight, and can be set to any given weight depending on the intended use of the fabric. In particular, when the multilayer nonwoven fabric is used for clothing such as protective clothing, the basis weight may range from 20 g/m² to 100 g/m² in view of strength and comfort as cloth.

The spunbond nonwoven fabrics 2 and 4 and the melt-blown nonwoven fabric 3 are laminated together as follows: first, on a nonwoven fabric in a lower layer (the spunbond nonwoven fabric 2 in FIG. 2 of the multilayer and long-fiber nonwoven fabric (A), resin is spun to form the melt-blown nonwoven fabric 3 as an intermediate layer. Next, on this melt-blown nonwoven fabric 3, resin is spun to continuously form the spunbond nonwoven fabric 4 acting as an upper layer so that the three-layer laminate is obtained. Then, a known calendar rolling technique (or an embossing rolling technique) is used to partially heat-seal the layers, together and form the multilayer and long-fiber nonwoven fabric (A) in which the spunbond nonwoven fabrics 2 and 4 and the melt-blown nonwoven fabric 3 are laminated together.

Moreover, in the nonwoven fabric composite 1 of this embodiment, multiple yarns (B) are used as shown in FIG. 1. The yarns (B) are spaced apart from each other.

Each of the yarns (B) is formed of fibers different from the fibers forming the multilayer and long-fiber nonwoven fabric (A). In the nonwoven fabric composite 1 of the present invention, the fibers of the yarn (B) are electrically conductive. Use of such electrically conductive fibers successfully provides the yarn (B) with antistatic properties derived from the electrical conductivity.

More specifically, examples of the electrically conductive fibers to be used include carbonaceous conductive fibers, metallic conductive fibers, and a composite of these fibers. Note that these fibers can be used alone, or in a combination of two or more.

Examples of the carbonaceous conductive fibers for the yarns includes conductive fibers bicomponent-spun from polymer in which conductive carbon is mixed, or conductive fibers made of fibers coated with conductive carbon using a binder. Alternatively, the carbonaceous conductive carbon fibers can be used either alone, or in combination with other fibers. Examples of the conductive fibers include “Clacarbo” manufactured by Kuraray Trading Co., Ltd., “CNTEC” manufactured by Kuraray Co., Ltd., “Belltron” manufactured by KB Seiren Co., Ltd., “Megana” manufactured by Unitika Trading Co., Ltd., “RESISTAT” manufactured by Shakespeare, “Torayca”, namely, carbon fibers manufactured by Toray Industries Inc., and “Pyrofil”, namely, carbon fibers manufactured by Mitsubishi Rayon Co., Ltd.

Moreover, examples of metallic conductive fibers for the yarns include fibers plated with metal and metal fibers. These fibers can be used either alone, or in combination with other fibers. Examples of metallic conductive fibers include silver-coated “SELMEC” manufactured by Kuraray Co., Ltd. “AGposs” manufactured by Mitsafuji Textile Ind Co., Ltd., and “ODEX Silver Yarns” manufactured by Osaka Deni Kogyo Co., Ltd. An example of metal fibers is “NASLON” manufactured by Nippon Seisen Co., Ltd.

In the present invention, use of such yarns (B) makes it possible to achieve good antistatic properties under a low-humidity condition. Such a feature allows the nonwoven fabric composite 1 to clear the explosion-proof standards according to JIST 8118.

Note that in view of providing the nonwoven fabric composite 1 with the antistatic properties to clear the explosion-proof standards according to JIST 8118, an average of spaced intervals T between the yarns (B) is preferably a predetermined interval or shorter, in particular, 2.5 cm or shorter.

Furthermore, in view of achieving good antistatic properties, the nonwoven fabric composite 1 has an amount of triboelectric charge smaller than or equal to preferably 7.0 μC/m² in compliance with JIST8118.

Moreover, the yarns (B) are not hunted to any particular kinds. Examples of the yarns may include spun yarns, multifilaments, monofilaments, and tape yarns all of which contain short fibers, and composite yarns of these yarns.

In addition, the antistatic nonwoven fabric composite 1 of this embodiment can be used for the purposes below, for example.

The nonwoven fabric composite 1 having the above SMS laminate is appropriately flexible and breathable as a clothing material, and is dust-proof with the filtering effect of an extra-fine melt-blown layer. Thanks to such features, the nonwoven fabric composite 1 is widely used for disposable protective clothing.

Use of the nonwoven fabric composite 1 of this embodiment can provide the disposable protective clothing with antistatic properties to clear an explosion-proof standard (0.6 μC/point) required for protective clothing in JIST 8118.

Such features can provide protective clothing in which a worker can work safely in a field particularly having a risk of explosion without depending on humidity condition. The protective clothing can be used for field works at, for example, chemical plants, chemistry laboratories, gas stations, paint shops, tankers, food processing factories, and printing factories in which explosive organic solvents and flammable powder are handled.

Moreover, the antistatic work clothes are used for works at clean rooms in which IT-related fight electrical parts are handled to keep the electrical parts from damages caused by static electricity collected in and discharged front the work clothes. That is why the antistatic nonwoven fabric composite 1 of this embodiment can be used as a cloth material for these work clothes.

Conventionally, two yarn fabrics containing long fibers have been mainly used for low-particle work clothes usable under an acceptable particle concentration of each class in a clean room. The yarn (B) introduced in the present invention may be used as electrically-conductive long fibers, so that the nonwoven fabric composite 1 can be implemented as a multilayer and long-fiber nonwoven fabric having low-particle properties suitable for use for the work clothes.

Furthermore, the nonwoven fabric composite 1 can be suitable for use in fields of hospitals and chemical analysis because workers in those fields handle precision instruments susceptible to damages and noise caused by discharge of static electricity.

Moreover, the nonwoven fabric composite can be used in a field of reducing an electric shock in discharge, which is one of the troubles caused by static electricity. The antistatic nonwoven fabric composite 1 of this embodiment can be used for materials for clothing, storage bags, and mats in order to reduce uncomfortable electric shocks caused by static charge in taking off clothes, taking a blanket out of a storage bag, and walking on a mat.

Furthermore, the nonwoven fabric composite 1 can be used in a field of alleviating a trouble of collecting static electricity to attract and gather dust in the air to look stained. For example, the nonwoven fabric composite 1 is used for various kinds of items such as packing materials, masking sheets, screens, and building materials to keep the surfaces of the items from collecting static electricity and reduce the risk of the items attracting and gathering dust to look stained.

Moreover, use of the antistatic nonwoven fabric composite 1 of this embodiment can solve a trouble of static cling in clothing.

Described next is a method for manufacturing a nonwoven fabric composite according to the embodiment of the present invention.

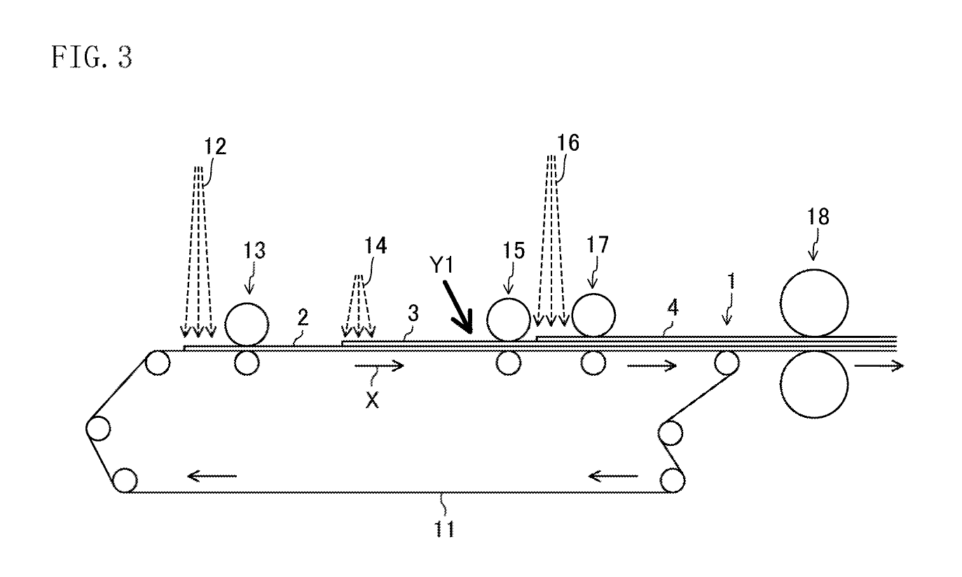

FIG. 3 is a schematic view illustrating a method for manufacturing the nonwoven fabric composite according to the embodiment of the present invention.

The manufacturing method of this embodiment includes manufacturing the multilayer and long-fiber nonwoven fabric (A) and introducing the yarn (B) by in-line lamination during the manufacturing of the multilayer and long-fiber nonwoven fabric (A).

### Manufacturing Multilayer and Long-Fiber Nonwoven Fabric

As illustrated in FIG. 3, first, fibers 12 obtained through melt spinning of resin are supplied on a running belt conveyor 11 shaped into an interlaced structure. The fibers 12 are then passed through a roller 13 to form the spunbond nonwoven fabric 2 containing continuous long fibers.

Here, as illustrated in FIG. 3, the belt conveyor 11 moves along an arrow X. Hence, the spunbond nonwoven fabric 2 is continuously formed on the belt conveyor 11.

Next, fibers 14, obtained through melt spinning of resin forming the melt-blown nonwoven fabric 3, is blown on the spunbond nonwoven fabric 2 with a high-speed and high-temperature air stream. With the effect of this air stream, the melt resin is stretched to form extremely fine fibers so that the melt-blown nonwoven fabric 3 containing continuous long fillers is formed on the spunbond nonwoven fabric 2.

### Introducing Yarn (B)

Next, the yarn (B) is introduced by in-line lamination on the melt-blown nonwoven fabric 3 which is a nonwoven fabric having the above two-layer laminate of SM.

Note that the “in-line lamination” here is to separately introduce the prepared yarn (B) in the partially manufactured multilayer and long-fiber nonwoven fabric (A) in the manufacturing, of the multilayer and long-fiber nonwoven fabric (A) containing two or more layers continuously combined together out of spunbonding and melt-blowing including one continuous process of forming a nonwoven fabric, and to produce a composite of the multilayer and long-fiber nonwoven fabric (A) and the yarn (B) in one step.

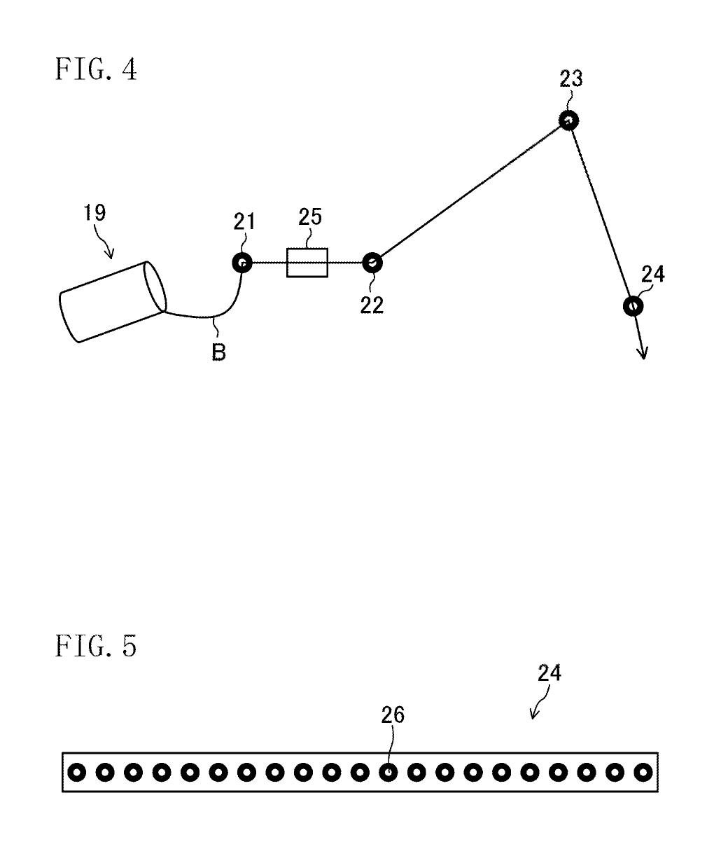

Next, the introduction of the yarn (B) is specifically described. As illustrated in FIG. 4, the yarn (B) is prepared as previously wound on, for example, a bobbin 19. The yarn (B) is released from the bobbin 19, travels through guides 21 to 23, and reaches a positioning guide 24. At a location Y1 illustrated in FIG. 3, the yarn (B) adheres to the nonwoven fabric (the melt-blown nonwoven fabric 3) on the belt conveyor 11. Then, in association with the move of the nonwoven fabric accompanied by the atone of the belt conveyor 11, the yarn (B) is also pulled and unreeled from the bobbin 19.

In this embodiment, the above technique is used to introduce the yarn (B) by in-line lamination during the manufacturing of the multilayer and long-fiber nonwoven fabric (A).

Note that, when variation in tension of the yarn (B) is great while the yarn (B) is unreeled from the bobbin 19 and reaches the positioning guide 24, the yarn (B) to be introduced in the multilayer and long-fiber nonwoven fabric (A) swings. That is why a spaced interval between the yarns is likely to vary. Hence, in view of stabilizing the tension of the yarn (B), a tension adjuster 25 may be provided as illustrated in FIG. 4.

The tension adjuster 25 can be a typical tension adjuster used when a reeled yarn is unreeled in warping of a woven fabric and producing a knitted fabric. Examples of typical tension adjusters include a washer tenser and a ring tenser manufactured by Yuasa Itomichi Co., Ltd.

Moreover, in order to obtain the antistatic properties to clear the explosion-proof standards according to JIST 8118 as described above, the average of each spaced interval T between the yarns (B) needs to be a predetermined distance or shorter. Hence, as illustrated in FIG. 5, the positioning guide 24 includes yarn introduction openings 26 spaced at predetermined intervals. The positioning guide 24 is provided to determine positions in which the yarns (B) are introduced, and control the spaced intervals T of the yarns (B).

### Manufacturing Nonwoven Fabric Composite

Next, the nonwoven fabric, having the laminate of SM including the spunbond nonwoven fabric 3 on which the yarns (B) are introduced, is passed through a roller 15. Then, on the melt-blown nonwoven fabric 3, fibers 16 obtained through melt spinning of resin are supplied to form the spunbond nonwoven fabric 4 containing continuous long fibers. The spunbond nonwoven fabric 4 is passed through a roller 17 so that the nonwoven fabric composite 1 is produced as illustrated in FIGS. 1 and 2.

Hence, during the introduction of the yarns (B) in this embodiment, the multilayer and long-fiber nonwoven fabric (A) is moved with the yarns (B) sandwiched between the nonwoven fabrics. This is how the yarns (B) are introduced in the multilayer and long-fiber nonwoven fabric (A).

Note that the produced nonwoven fabric composite 1 moves along the arrow X by the belt conveyor 11 to pass through a roller 18, and is sent outside.

As described above, in this embodiment, the yarns (B) are introduced by in-line lamination. Compared with the above typical techniques, the in-line lamination makes it possible to provide the nonwoven fabric composite 1 that can clear the explosion-proof standards with fewer steps at a lower cost.

As illustrated in FIG. 2, this embodiment can implement a structure in which the yarns (B) are provided between the melt-blown nonwoven fabric 3 (the intermediate layer) and the spunbond nonwoven fabric 4 (the upper layer) of the multilayer and long-fiber nonwoven fabric (A); that is, the yarns (B) are arranged on the melt-blown nonwoven fabric 3. Such a structure makes it possible to introduce the yarns (B) on a laminate of melt-blown extremely fine fibers. Hence, the yarns (B) are pushed into the soft melt-blown nonwoven fabric 3, and the spunbond nonwoven fabric 4 is laminated as an upper layer on the melt-blown nonwoven fabric 3. Such a structure allows the yarns (B) to be contained in the multilayer and long-fiber nonwoven fabric (A), facilitating the multilayer and long-fiber nonwoven fabric (A) and the yarns (B) to integrate with each other.

Note that the embodiment may be modified as described below.

The multilayer and long-fiber nonwoven fabric (A) in the above embodiment is a three-layer laminate (an SMS laminate) including two layers of the spunbond nonwoven fabrics 2 and 4 and one layer of the melt-blown nonwoven fabric 3 alternately laminated, with the melt-blown nonwoven fabric 3 provided as an intermediate layer. Alternatively, the multilayer and long-fiber nonwoven fabric (A) may be formed in other structures as long as the fabric includes at least one of a spunbond nonwoven fabric or a melt-blown nonwoven fabric. For example, the multilayer and long-fiber nonwoven fabric may be formed in a three-layer laminate (an MSM laminate) including two layers of melt-blown nonwoven fabrics and one layer of a spunbond nonwoven fabric alternately laminated, with the spunbond nonwoven fabric provided as an intermediate layer. Alternatively, the multilayer and long-fiber nonwoven fabric (A) may be formed in a three-layer laminate (an SSS laminate) including multiple spunbond nonwoven fabrics only.

Moreover, in the above embodiment, the yarns (B) are introduced by in-line lamination on the melt-blown nonwoven fabric 3 having a two-layer laminate of SM. However, the yarns (B) in the in-line lamination of the present invention may be introduced with any given timing as long as the yarns (B) are introduced during the manufacturing of the multilayer and long-fiber nonwoven fabric (A).

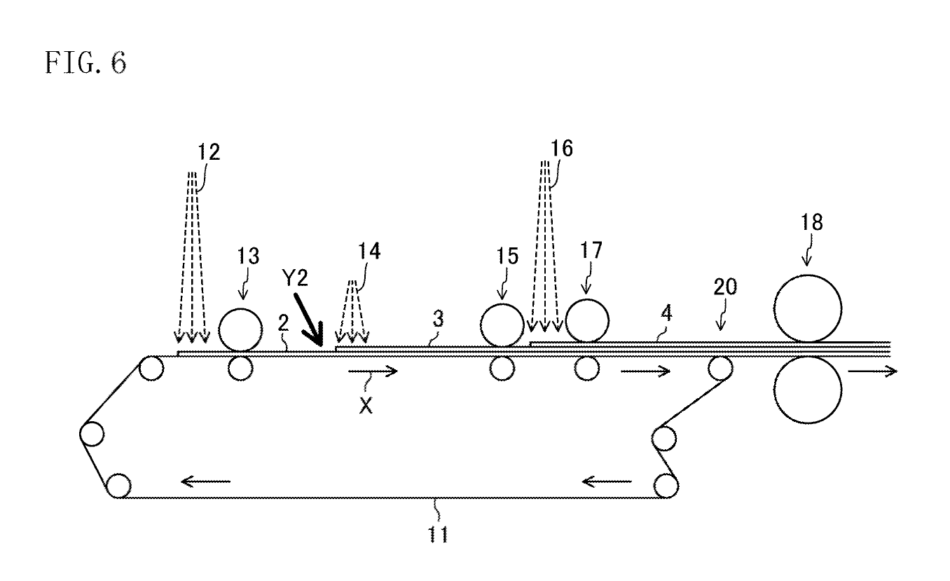

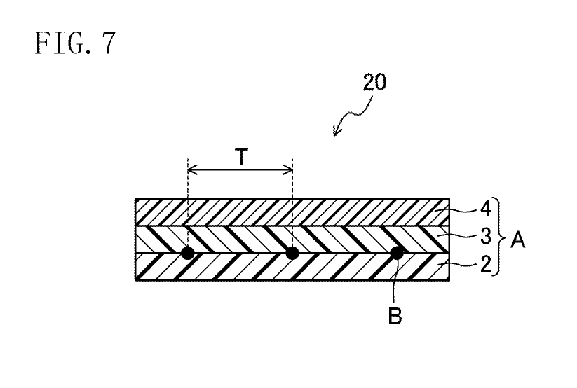

For example, the fibers 12 obtained through melt spinning of resin are supplied on the belt conveyor 11, and then passed through the roller 13 to form the spunbond nonwoven fabric 2. After that, the yarn (B) released from the bobbin 19 is attached to the spunbond nonwoven fabric 2 at a location Y2 on the belt conveyor 11 illustrated in FIG. 6. Then, in a similar manner as seen in the above embodiment, the melt-blown nonwoven fabric 3 as an intermediate layer is formed on the spunbond nonwoven fabric 2, and the spunbond nonwoven fabric 4 is formed on the melt-blown nonwoven fabric 3. As a result, a nonwoven fabric composite 20 can be obtained as illustrated in FIG. 7.

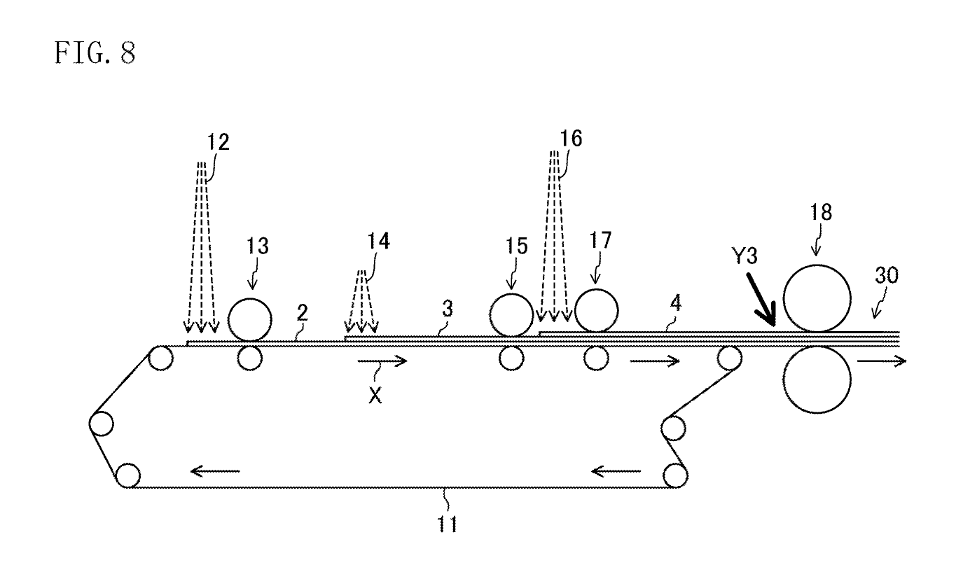

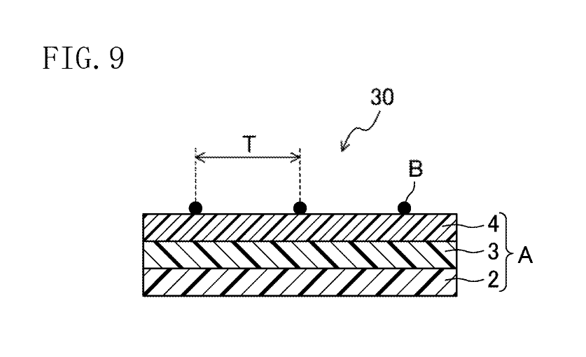

Moreover, as illustrated in FIG. 8, first, the multilayer and long-fiber nonwoven fabric (A) is formed in a three-layer laminate (an SMS laminate) including the spunbond nonwoven fabrics 2 and 4 and the melt-blown nonwoven fabric 3 alternately laminated, with the melt-blown nonwoven fabric 3 provided as an intermediate layer. Then, the yarn (B) released from the bobbin 19 is attached to the spunbond nonwoven fabric 4 acting as an upper layer of the multilayer and long-fiber nonwoven fabric (A) at a location Y3 illustrated in FIG. 8. As a result, a nonwoven fabric composite 30 can be obtained as illustrated in FIG. 9.

Note that, in this case, the yarn (B) is attached to a surface of the previously manufactured multilayer and long-fiber nonwoven fabric (A). That is why an adhesive and heat-seal fibers need to be used to fix the yarn (B) on the surface of the multilayer and long-fiber nonwoven fabric (A) to reduce the risk of the yarn (B) coming off.

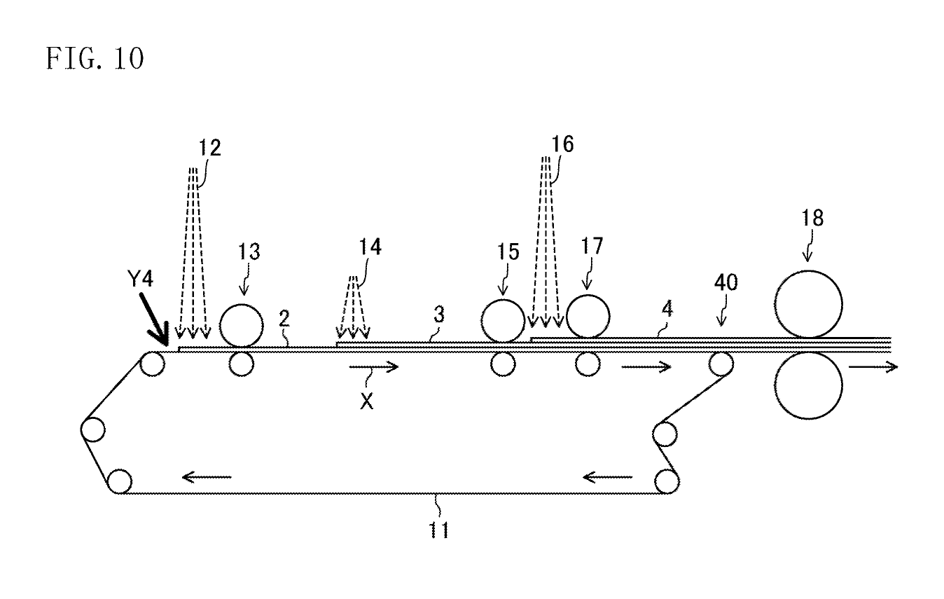

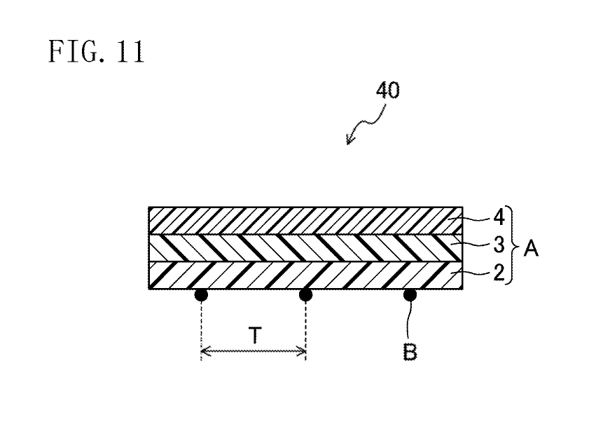

Furthermore, as illustrated in FIG. 10, first, the yarn (B) released from the bobbin 19 is attached to the belt conveyor 11 at a location Y4 illustrated in FIG. 10. Then, on the yarn (B), the multilayer and long-fiber nonwoven fabric (A) is formed in a three-layer laminate (an SMS laminate) including the spunbound nonwoven fabrics 2 and 4 and the melt-blown nonwoven fabric 3 alternately laminated, with the melt-blown nonwoven fabric 3 provided as an intermediate layer. As a result, a nonwoven fabric composite 40 can be obtained as illustrated in FIG. 11.

Note that, the yarn (B) is attached also to the surface of the previously manufactured multilayer and long-fiber nonwoven fabric (A) in a similar manner as seen in the case of the above nonwoven fabric composite 30. That is why an adhesive and heat-seal fibers need to be used to fix the yarn (B) on the surface of the multilayer and long-fiber nonwoven fabric (A) to reduce the risk of the yarn (B) coming off.

In the above embodiment, the yarn (B) has, but not limited to, antistatic properties derived front electrical conductivity. Examples of the properties include: electromagnetic wave blockage derived from electrical conductivity; high strength, high, shrinkage, low shrinkage, moisture absorbency, far-infrared ray emission, heat storage and retention, moisture absorbency and heat emission, hydrophilicity, hydrophobicity, air freshening, insect repellent effects, insecticide effects, insect and animal attractant effects, antibacterial effects, mold-resistant effects, and fragrance.

Depending on purposes, introduction of the yarn with these properties allows the multilayer and long-fiber nonwoven fabric of the present invention to additionally have a function which a typical multilayer and long-fiber nonwoven fabric is short of or lacks.

Moreover, in the above embodiment, the positioning guide 24 is used in the introducing to introduce the yarn (B). However a common technique can also be used to insert a weft yarn, or a well insertion apparatus may be used to introduce the yarn (B). In weaving examples of apparatuses to insert a weft yarn between warp yarns include such looms as a rapier loom, a gripper loom, a water jet loom, and an air jet loom. Among these looms, the air jet loom achieves a high count of weft yarn insertion, and may preferably be employed. In this case, the yarns (B) are intermittently introduced at substantially constant and spaced intervals in a direction generally orthogonal to the move of the nonwoven fabric on the above belt conveyor 11. Furthermore, this technique can be combined with the introduction of the yarn disclosed in the above embodiment. (That is, the yarns (B) are attached to the nonwoven fabric on the belt conveyor 11, and, in association with the move of the nonwoven fabric accompanied by the move of the belt conveyor 11, the yarns (B) are pulled and unreeled from the bobbins 19.) As a result, the yarns can be arranged also in a substantial lattice.

Moreover, colored yarns may be used as the yarns (B), or the arrangement of the yarns (B) in the nonwoven fabric composite 1 may be changed to provide the nonwoven fabric composite 1 with a design.

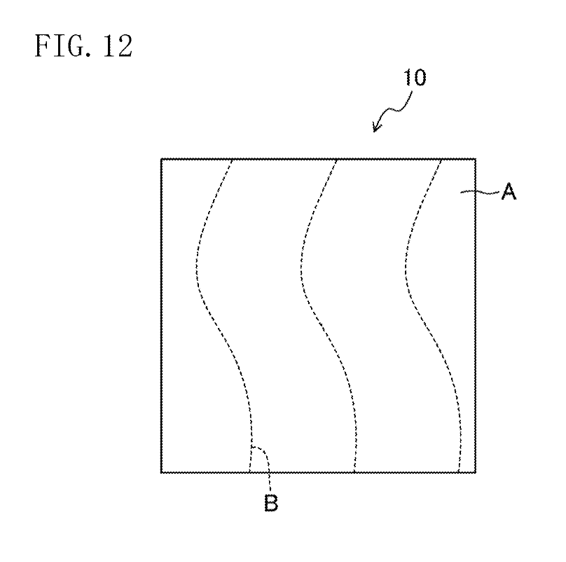

More specifically, for example, the yarns (B) are introduced in the multilayer and long-fiber nonwoven fabric (A) in other fashions than a liner one on purpose. As illustrated in FIG. 12, for example, the yarns (B) are introduced in wavy curved lines so that the appearance of the obtained nonwoven fabric composite 10 can have a design. Note that, in this case, for example, the above tension adjuster 25 is used to vary the tension of the yarn (B) when the yarn (B) is introduced. Alternatively, the positioning guide 24 is moved on purpose when the yarn (B) is introduced.

Note that an example of a possible manufacturing method not applicable to a method for manufacturing the nonwoven fabric composite of the present invention would not utilize the above in-line lamination when famine a composite of a multilayer and long-fiber nonwoven fabric and a separately prepared yarn. Specifically, for example, in bonding two kinds of previously manufactured long-fiber nonwoven fabrics together, the possible manufacturing method could involve introducing the yarn between the two kinds of long-fiber nonwoven fabrics to form an integrated composite. However, this manufacturing method is disadvantageous because of increasing costs due to the need of two steps; namely, manufacturing the nonwoven fabrics and bonding the nonwoven fabrics. Hence, manufacturing methods other than the in-line lamination of the present invention cause an increase in the number of steps, and are disadvantageous in terms of costs.

### EXAMPLES

The present invention is described below based on examples. Note that the present invention shall not be limited to these examples. These examples may be modified and changed based on the intent of the present invention. Such a change and modification shall not be excluded from the scope of the invention.

### Example 1

### Producing Nonwoven Fabric Composite

With an SMS manufacturing machine having a width of 2.4 m, yarns containing electrically conductive fibers were introduced during manufacturing of a multilayer and long-fiber nonwoven fabric (50 g/m²) formed in a three-layer laminate (an SMS laminate) containing polypropylene resin as a raw material.

More specifically, first, Clacarbo (Manufactured by Kuraray Trading Co., Ltd. Trade Name: C22T4) and polyester multifilaments (Manufactured by Toray Industries Inc. Trade Name: SD56T18) were interlaced and blended together to form composite yarns as electrically conductive yarns. One hundred and twenty five of such yarns were wound on bobbins to be ready for use.

Next, a positioning guide was set, The positioning guide had 125 yarn introduction openings linearly spaced at a pitch distance, of 20 mm. The 125 yarns were passed through the respective 125 yarn introduction openings of the positioning guide. Then, using the above SMS manufacturing machine, a melt-blown nonwoven fabric was formed on a spunbond nonwoven fabric. After that, the ends of the 125 yarns were attached to this melt-blown nonwoven fabric via the positioning guide. The yarns were set ready to be pulled and unreeled from the bobbins in association with the move of the nonwoven fabric accompanied by the move of the belt conveyor. Hence, the yarns were introduced on the melt-blown nonwoven fabric.

Next, the nonwoven fabric, having a laminate of SM including the melt-blown nonwoven fabric on which the yarns were introduced, was passed through a roller. Then, on the melt-blown nonwoven fabric, a spunbond nonwoven fabric was formed with the SMS manufacturing machine. The fabrics were passed through the roller again so that a nonwoven fabric composite was obtained. The nonwoven fabric composite included the melt-blown nonwoven fabric as an intermediate layer, the spunbond nonwoven fabric as an upper layer, and the yarns introduced therebetween.

Note that the introduced 125 yarns were spaced at intervals of 20 mm on average. Moreover, a tension adjuster (Manufactured by Yuasa Itomichi Co., Ltd. Trade Name: Washer Tenser) was installed in a route in which the yarns traveled from the bobbins to the positioning guide to reduce a variation in tension of the yarns when the yarns were unreeled and released from the bobbins.

### Measuring Amount of Triboelectric Charge

Next, an amount of triboelectric charge of the produced nonwoven fabric composite was measured with a triboelectric charge measurement apparatus (Manufactured by ADC Corporation. Trade Name: Digital Electrometer) in compliance with JIST 8118 under a condition of 20° C. and 30% RH.

Moreover, a one-piece jumpsuit as protective clothing was produced using the obtained nonwoven fabric composite, and under a similar condition, an amount of triboelectric charge of this protective clothing was measured. Moreover, the measurement condition was changed to 20° C. and 20% RH, and amounts of triboelectric charge of the produced nonwoven fabric composite and protective clothing were measured. Table 1 shows the results.

### Example 2

First, Clacarbo (Manufactured by Kuraray Trading Co., Ltd: Trade Name: C22T4) were used as electrically conductive yarns. One hundred of these electrically conductive yarns were wound on bobbins to be ready for use.

Next, a positioning guide was set. The positioning guide had 100 yarn introduction openings linearly spaced at a pitch distance of 25 mm. The 100 yarns were passed through the respective 100 yarn introduction openings of the positioning guide. Then, using the above SMS manufacturing machine, a melt-blown nonwoven fabric was formed on a spunbond nonwoven fabric. After that, the ends of the 100 yarns were attached to the melt-blown nonwoven fabric via the positioning guide. The yarns were set ready to be pulled and unreeled from the bobbins in association with the move of the nonwoven fabric accompanied by the move of the belt conveyor. Hence, the yarns were introduced on the melt-blown nonwoven fabric.

Next, the nonwoven fabric, having a laminate of SM including the melt-blown nonwoven fabric on which the yarns were introduced, was passed through a roller. Then, on the melt-blown nonwoven fabric, a spunbond nonwoven fabric was formed with the SMS manufacturing machine. The fabrics were passed through the roller again so that a nonwoven fabric composite (50 g/m²) was obtained. The nonwoven fabric composite included the melt-blown nonwoven fabric as an intermediate layer, the spunbond nonwoven fabric as an upper layer, and the yarns introduced therebetween.

Note that the introduced 100 yarns were spaced at intervals of 25 mm on average. Moreover, similar to above Example 1, a tension adjuster (Manufactured by Yuasa Itomichi Co., Ltd. Trade Name: Washer Tenser) was installed in a route in which the yarns traveled from the bobbins to the positioning guide to reduce a variation in tension of the yarns when the yarns were unreeled and released from the bobbins.

Then as seen in the above Example 1, the amount of triboelectric charge was measured. Table 1 shows the results.

### Comparative Example 1

Except that electrically conductive yarns were not used, a nonwoven fabric composite was produced in a similar manner as the above Example 1. Then, as seen in the above Example 1, an amount of triboelectric charge of the nonwoven fabric composite was measured under a condition of 20° C. and 30% RH. Table 1 shows the results.

### Comparative Example 2

An antistatic agent (Manufactured by Kao Corporation. Trade Name: Electro Stripper QN) was diluted with 100 times the amount of liquid. The diluted solution was sprayed as much as approximately 100 g/m² on the nonwoven fabric composite produced in Comparative Example 1, and dried at room temperature.

Then, as seen in the above Example 1, an amount of triboelectric charge of the nonwoven fabric composite was measured under conditions of 20° C. and 30% RH, and 20° C. and 20% RH. Table 1 shows the results.

TABLE 1

| | | Amount of Triboelectric | Amount of Triboelectric | Amount of Triboelectric | Amount of Triboelectric |
|---|---|---|---|---|---|
| | | Charge in Nonwoven | Charge in Nonwoven | Charge in Protective | Charge in Protective |
| | | Fabric Composite | Fabric Composite | Clothing | Clothing |
| | Antistatic | [μC/m²] | [μC/m²] | [μC/point] | [μC/point] |
| | Treatment | (20° C./30% RH) | (20° C./20% RH) | (20° C./30% RH) | (20° C./20% RH) |
| Example 1 | Electrically | 5.0 | 5.0 | 0.41 | 0.42 |
| | Conductive | | | | |
| | Yarns | | | | |
| Example 2 | Electrically | 5.9 | 6.0 | 0.51 | 0.51 |
| | Conductive | | | | |
| | Yarns | | | | |
| Comparative | None | 12.4 | — | — | — |
| Example 1 | | | | | |
| Comparative | Antistatic | 6.8 | 8.9 | — | — |
| Example 2 | Agent | | | | |

As shown in Table 1, the nonwoven fabric composites of Examples 1 and 2, including a multilayer and long-fiber nonwoven fabric with electrically conductive yarns introduced by in-line lamination, have an amount of triboelectric charge smaller than or equal to 7.0 μC/m² which is an explosion-proof standard according to JIS T8118. These nonwoven fabric composites are found to have antistatic properties which clear the explosion-proof standard.

Moreover, the one-piece jumpsuits as protective clothing produced with the nonwoven fabric composites of Examples 1 and 2 have an amount of triboelectric charge smaller than or equal to 0.6 μC/point which is an explosion-proof standard according to JIS T8118. These one-piece jumpsuits are found to have antistatic properties which clear the explosion-proof standard.

Meanwhile, as shown in Table 1, the nonwoven fabric composite of Comparative Example 1, including a multilayer and long-fiber nonwoven fabric with no electrically conductive yarns introduced, by in-line lamination, has an amount of triboelectric charge significantly exceeding the explosion-proof standard of 7.0 μC/m². This nonwoven fabric composite is found to have poor antistatic properties.

Moreover, as shown in Table 1, the nonwoven fabric composite of Comparative Example 2 treated with the antistatic agent has an amount of triboelectric charge smaller than or equal to the explosion-proof standard of 7.0 μC/m² in relatively high humidity (30% RH). However, the nonwoven fabric composite significantly exceeds the explosion-proof standard of 7.0 μC/m² under a low humidity condition (20% RH). The nonwoven fabric composite of Comparative Example 2 is found to have poor antistatic properties under a low humidity condition.

### INDUSTRIAL APPLICABILITY

As can be seen, the present invention is particularly useful for a nonwoven fabric composite including: a multilayer and long-fiber nonwoven fabric; and a yarn containing functional fibers and introduced in the multilayer and long-fiber nonwoven fabric. The present invention is also useful for a method for manufacturing such a nonwoven fabric composite.

### DESCRIPTION OF REFERENCE CHARACTERS

1 Nonwoven Fabric Composite
2 Spunbond Nonwoven Fabric
3 Melt-Blown Nonwoven Fabric
4 Spunbond Nonwoven Fabric
10 Nonwoven Fabric Composite
11 Belt Conveyor
12 Fibers Obtained through Melt Spinning of Resin
14 Fibers Obtained through Melt Spinning of Resin
16 Fibers Obtained through Melt Spinning of Resin
19 Bobbin
20 Nonwoven Fabric Composite
24 Positioning Guide
26 Yarn introduction Openings
30 Nonwoven Fabric Composite
A Multilayer and Long-Fiber Nonwoven Fabric
B Yarn
T Spaced Interval between Yarns
Y1 to Y4 Locations of Yarns to Adhere

1. A nonwoven fabric composite comprising:
a multilayer and long-fiber nonwoven fabric (A) which is a laminate of nonwoven fabrics continuously obtained through spinning melted resin formable into fibers; and a yarn (B) formed of fibers different from the fibers forming the multilayer and long-fiber nonwoven fabric (A), and introduced in the multilayer and long-fiber nonwoven fabric (A) by in-line lamination,
wherein the fibers of the yarn (B) comprise electrically conductive fibers.

2. The nonwoven fabric composite of claim 1, wherein
the yarn (B) comprises yarns (B) spaced apart from each other, and
the nonwoven fabric composite has an amount of triboelectric charge smaller than or equal to 7.0 μC/m² measured in compliance with JIST 8118.

3. The nonwoven fabric composite of claim 1, wherein the multilayer and long-fiber nonwoven fabric (A) comprises a spunbound nonwoven fabric, a melt-blown nonwoven fabric, or both.

4. The nonwoven fabric composite of claim 1, wherein the resin is at least one selected from the group consisting of polypropylene, polyethylene, polyester, polyamide, and a modified polymer comprising at least one selected from the group consisting of polypropylene, polyethylene, polyester, and polyamide.

5. A method for manufacturing a nonwoven fabric composite comprising:
a multilayer and long-fiber nonwoven fabric (A) which is a laminate of nonwoven fabrics continuously obtained through spinning melted resin formable into fibers; and a yarn (B) formed of fibers different from the fibers forming the multilayer and long-fiber nonwoven fabric (A), and introduced in the multilayer and long-fiber nonwoven fabric (A), the method comprising
introducing the yarn (B) by in-line lamination during manufacturing of the multilayer and long-fiber nonwoven fabric (A),
wherein the fibers of the yarn (B) comprise electrically conductive fibers.

6. The method of claim 5, wherein
in the introducing, the yarn (B) comprises yarns (B) spaced apart from each other, and
the nonwoven fabric composite has an amount of triboelectric charge smaller than or equal to 7.0 μC/m² measured in compliance with JIST 8118.

7. The method of claim 5, wherein the multilayer and long-fiber nonwoven fabric (A) comprises a spunbond nonwoven fabric, a melt-blown nonwoven fabric, or both.

8. The method claim 5, wherein the resin is at least one selected from the group consisting of polypropylene, polyethylene, polyester, polyamide, and a modified polymer comprising at least one selected from the group consisting of polypropylene, polyetheylene, polyester, and polyamide.

9. The method of claim 5, wherein during the introducing of the yarn (B), the multilayer and long-fiber nonwoven fabric (A) is moved with the yarn (B) sandwiched between the nonwoven fabrics.
